(19) United States
(12) Patent Application Publication
(10) Pub. No.: US 2004/0206218 A1
(43) Pub. Date: Oct. 21, 2004

(54) Beveling tool

(76) Inventor: Jerry Nybo, Eatonville, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/420,105

(22) Filed: Apr. 18, 2003

(51) Int. Cl. B23B 5/08

(52) U.S. Cl. 82/113

(57) ABSTRACT

The present invention is related to a beveling tool, and more specifically to an attachment that can be mounted to a driver to bevel the outer edges of plastic pipes.

### FIELD OF THE INVENTION

The present invention is related to a beveling tool, and more specifically to an attachment that can be mounted to a driver to bevel the outer edges of plastic pipes.

### BACKGROUND OF THE INVENTION

Joining a plastic pipe to a fitting or coupling requires that one end of a plastic pipe be inserted into the coupling or fitting. Plastic pipes and fittings are normally held together with the use of rubber gaskets. The gaskets also provide a tight seal between the fitting and the pipe to prevent leakage. The gaskets have an outer diameter that is about the same size as the fitting inner diameter so that the gasket is snug on the fitting. The gasket also has an inner diameter that is about the same size as the pipe outer diameter to also provide a snug fit between the gasket and pipe. However, during the insertion of a plastic pipe into a fitting, the closeness of the gasket and pipe size makes the insertion operation difficult. One solution to this problem has been to bevel the exterior edge of the pipe end so that the pipe end has a slightly smaller outer diameter than the gasket inner diameter. The pipe end can be beveled for about one inch or so, to provide a gradually increasing outer pipe diameter. Conventional beveling tools for this purpose are manually operated tools. Repetitive-use syndrome can be a problem with the presently available manual tools. Also, manual tools can leave a rough or uneven edge that compromises the seal between the pipe and fitting. Accordingly, there is a need for a beveling tool that overcomes the problems inherent with the prior art, and provides further related advantages.

### SUMMARY OF THE INVENTION

A beveling tool according to the present invention is provided. In one embodiment, the beveling tool includes a driver, a bit connected to the driver, and an attachment connected to the driver. The attachment includes a plate, a guide mounted to the plate, and one or more inserts on the plate, and the one or more inserts approximately define one or more points on one or more circles, wherein each circle has a point at a location between the guide and the bit.

Another embodiment of a beveling tool includes a driver with a shaft, a bit connected to the shaft, and an attachment connected to the driver. The attachment includes a plate, a guide on the plate, wherein the bit protrudes through the plate, and wherein the attachment includes one or more inserts and the one or more inserts and the guide approximately define one or more points on a circle.

Another embodiment of the beveling tool includes a plate, a guide mounted to the plate, and one or more inserts on the plate, wherein the guide and the one or more inserts approximately define points on one or more circles.

Another embodiment of the beveling tool includes a driver having a shaft, a bit connected to the shaft, and an attachment connected to the driver. The attachment includes a plate; a roller guide mounted on one side of the plate that is opposite to the side connected to the driver; an aperture in proximity to the guide, wherein the bit protrudes through the aperture; and at least one insert, wherein the outermost surface of the insert and the outermost surface of the guide approximately define points on a circle.

Another embodiment of a beveling tool includes a plate, a guide on the plate, and at least one insert wherein the outermost surface of the insert and the outermost surface of the guide define points on a circle.

The present invention provides numerous advantages. For example, the beveling tool requires less effort to bevel a pipe than what is required using a manual device. The present invention also provides a consistent bevel without any of the disadvantages of prior art devices.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a perspective illustration of one embodiment of a beveling tool according to the present invention;

FIG. 2 is an exploded illustration of the beveling tool of FIG. 1;

FIG. 3 is a perspective illustration of a tool attachment according to the present invention;

FIG. 4 is a plan illustration of a tool attachment according to the present invention;

FIG. 5 is a cross-sectional illustration of a tool attachment according to the present invention;

FIG. 6 is a perspective illustration of a second embodiment of a beveling tool according to the present invention; and

FIG. 7 is a plan illustration of the tool attachment of FIG. 6.

### DETAILED DESCRIPTION OF THE PREFERRED EMBODIMENT

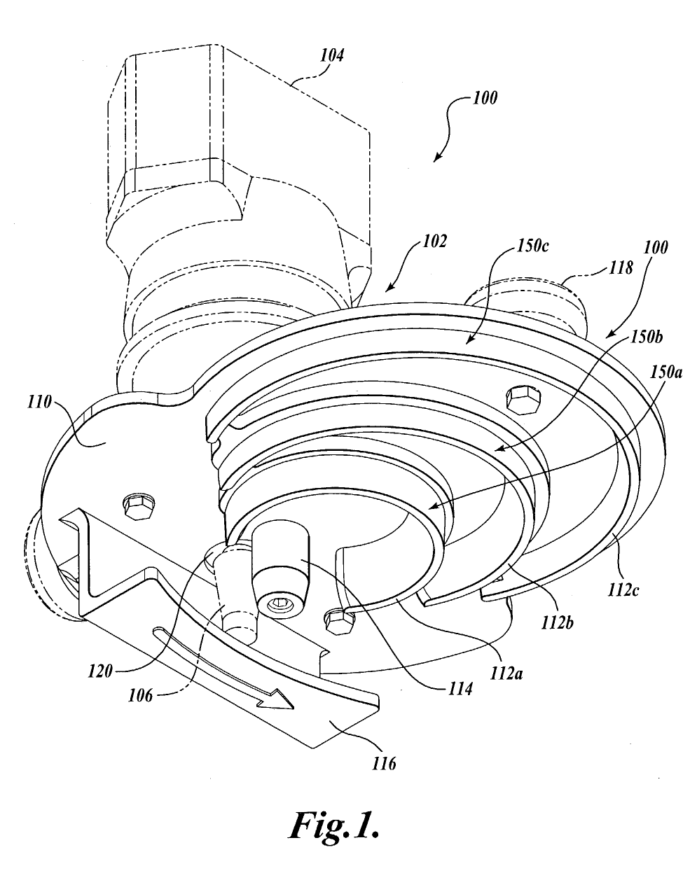

Referring to FIG. 1, one embodiment of a beveling tool 100 according to the present invention includes a driver 102, optionally having a battery 104. A beveling tool attachment 108 is connected to the driver 102. The attachment 108, further comprises a plate 110. A roller guide 114 is connected to the plate 110. An aperture 120 is provided adjacent the roller guide 114. The driver 102 includes a shaft (not shown) to which a bit 106 is connected at an end thereof. The driver 102 can be a commercial battery-operated driver, such as a driver for a commercial router available under the designation PORTER CABLE Model No. 1001, from the Porter Cable Company of Jackson, Tenn. The attachment 108, further comprises one or more inserts. Inserts are members on the plate 110 that can be inserted within the inside of pipe to be beveled, so that the pipe rests on the inserts to hold the pipe while the pipe is worked on. Inserts lie approximately at the circumference of a circle that can correspond to standardized pipe sizes. In the embodiment shown in FIG. 1, the attachment includes three inserts 112a, 112b, and 112c. The inserts 112a-112c are connected to the side of the plate 110 to which the roller guide 114 is also connected. The bit 106 protrudes through the aperture 120 in the plate 110, so that the bit 106 is adjacent the roller guide 114. The attachment 108 and related components are manufactured of standard materials, including iron, steel, aluminum, plastics, and other durable, natural or synthetic materials.

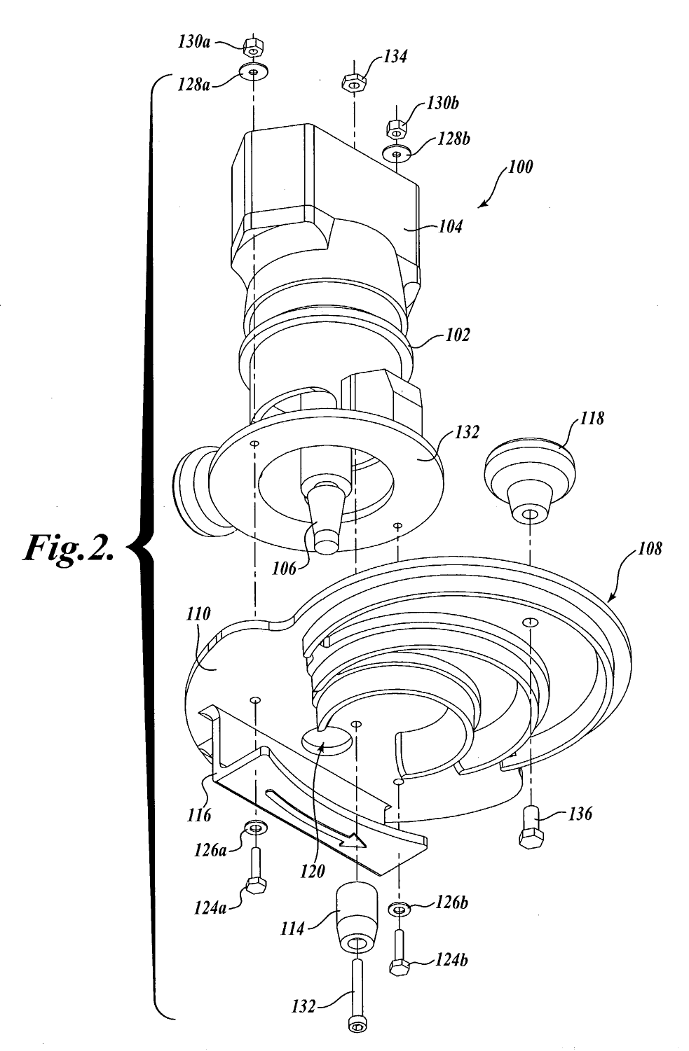

Referring now to FIG. 2, an illustration showing the interconnection of the components of the present invention is provided. Apertures on the plate 110 allow for bolts 124a, 124b to be inserted therethrough to mate with corresponding bolt holes provided on a mounting plate 132 on the driver 102. Nuts 130a and 130b are threaded to the bolts 124a and 124b to fix the attachment 108 to the driver 102. Washers 126a and 126b, and 128a and 128b may also be provided on bolts 124a and 124b. Referring still to FIG. 2, an aperture 120 is provided on the plate 110 to allow the bit 106 connected to the driver 102 to pass therethrough. A bolt hole is provided adjacent the aperture 120 to mount the guide 114 thereto. The guide 114 is held to the plate 110 by bolt 132. Guide 114 can be configured and arranged so as to readily rotate about the bolt 132. Guide 114 has a cylindrical body that tapers inward at the distal end. The attachment 108 can further be provided with a knob 118 connected to the plate 110 by the bolt 136. The knob 118 provides a grasping location for ease of handling the beveling tool.

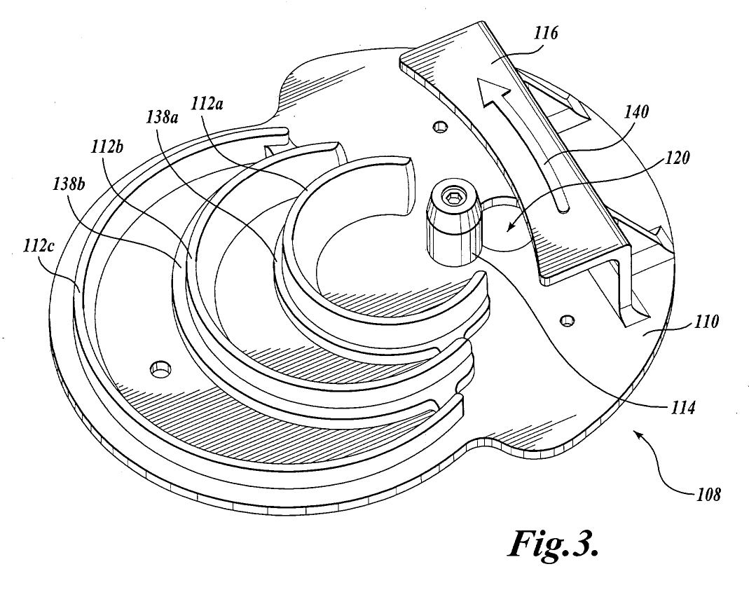

Referring now to FIG. 3, a perspective illustration of the attachment 108 is provided. The attachment 110 has the roller guide 114 mounted on one side of the plate 110. A series of three inserts 112a, 112b, and 112c are mounted on the same side as the roller guide 114. Insert 112a is the smallest of the three inserts, followed by 112b, and then 112c. A guard 116 is provided on the plate 110 so that the guard 116 is located opposite to the roller guide and adjacent the aperture 120. The guard 116 prevents debris from being flung in an undesired direction. An arrow 140 can be provided on the upper surface of the guard 116 to indicate the desired rotation of the pipe. Inserts 112a and 112b are provided with ledges 138a and 138b, respectively, on a lower and outer location thereof. The ledges 138a and 138b can be varied in height so as to determine the depth of the bevel that is made by the tool. For example, if the ledges are increased in height, the pipe end would sit against the ledge and the length of the beveled area would be reduced. Alternatively, if the ledge were decreased in height, the pipe would come to rest further in and more of the end of the pipe would be beveled. Alternatively, no ledge can be provided adjacent the insert. For example, insert 112c does not have a ledge adjacent thereto. In this case, the pipe can rest directly on the plate 110.

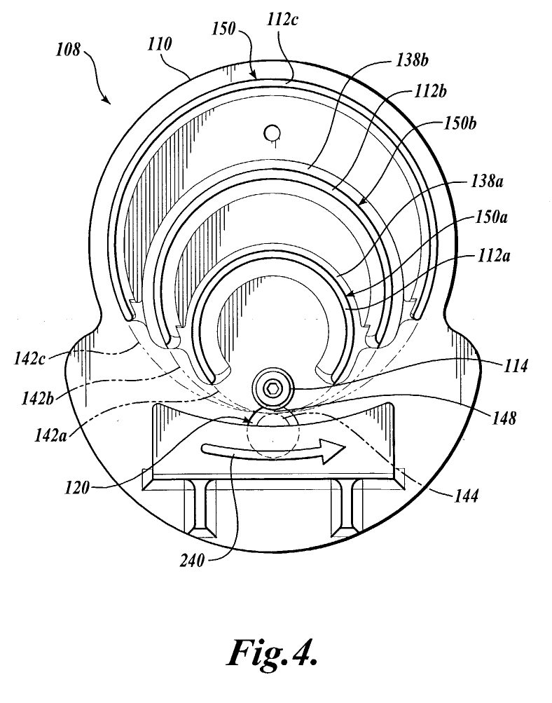

Referring now to FIG. 4, the working side of the tool attachment 108 is illustrated. The attachment 108 is shown comprising a series of increasingly larger diameter inserts 112a, 112b, and 112c. Ledges 138a and 138b are provided adjacent the inserts 112a and 112b. In one aspect of the invention, the outermost surfaces 150a, 150b, and 150c of the inserts 112a, 112b, and 112c approximately define the circumference of circles designated 142a, 142b, and 142c, respectively. Inserts 112a, 112b, and 112c may also be viewed as approximately defining tangential points along a majority of the circumference of circles 142a, 142b, and 142c. The inserts 112a, 112b, and 112c are continuous for a majority of the circumference of the circles. However, alternate embodiments of inserts 112a, 112b, and 112c can be provided that are discontinuous or are a discrete series of inserts. However, even under these circumstances, the inserts can be made to lie adjacent or approximately on the circumference of circles 142a, 142b, and 142c. In one aspect of the present invention, the circles 142a, 142b, and 142c approximately correspond to the inner circumferences of standardized pipe sizes. In this manner, the pipe can fit snugly on the inserts with minimal play while being worked on. In the embodiment illustrated in FIG. 4, pipes can be inserted so that the pipe's inside circumference can lie adjacent the outermost surfaces, 150a, 150b, and 150c of the pipe inserts 112a, 112b, and 112c. As mentioned previously, a pipe end can come to rest on ledge 132a, adjacent pipe insert 112a, or a pipe can come to rest on the ledge 132b, adjacent insert 112b. Alternatively, the pipe end can come to rest directly on the plate 110. Inserts 112a, 112b, and 112c project approximately perpendicular to the plate 110, so that a pipe can rest on a majority of the surface 150a, 150b, and 150c. Inserts 112a, 112b, and 112c can be made to correspond with inner pipe diameters of 4, 6, or 8 inches, or of any other inner pipe diameter. Fewer than three pipe inserts can be provided on the plate. Alternatively, more than three inserts can be provided.

Referring still to FIG. 4, the roller guide 114 is provided in a manner such that the outermost surface of the guide 114 also approximately lies adjacent or on a tangent point on each of the circles 142a, 142b, and 142c. Thus, guide 114 lies at a common tangential point of circles 142a, 142b, and 142c. In another aspect of the present invention, the circles 142a, 142b, and 142c defined by inserts 112a, 112b, and 112c, and the guide 114 have a common tangential point approximately located between the roller guide 114, and the router bit 106, shown in phantom by reference numeral 144. In another aspect of the present invention, the inserts 112a, 112b, and 112c define a continuous series of tangent points along circles 142a, 142b, and 142c, respectively. However, other alternates of the attachment 108 can have discrete or discontinuous members abutting tangent points located on the circles 142a, 142b, and 142c. Other alternates of inserts may not have entirely all of the insert's outer surface lie on the circumference of the circle. This is especially true for the larger pipe sizes when the insert may take the shape of a flattened circle, rather than a sphere. This prevents the tool from being excessively wide and unwieldy. Other embodiments may have inserts that lie on less than the majority of the circumference of a circle. The object again is to minimize the width of the plate while attempting to accommodate larger pipe sizes. In cases of irregularly shaped inserts, the furthermost point from the guide will typically be the defining tangent point of a circle. Thus, in some cases, a circle can be defined by a single tangent point set by the insert, and a tangent point set by the guide. Aperture 120 is provided on the plate 110 for the router bit 106 to pass through the plate 110 and lie adjacent the roller guide 114. The reference numeral 144 denotes the outline of the bit 106. Therefore, the bit 106 also lies adjacent the common tangential point of circles 142a, 142b, and 142c. Other embodiments of the attachment 108 according to the present invention can have any number of inserts to accommodate a variety of pipe sizes and, thus, maximize the tool's use.

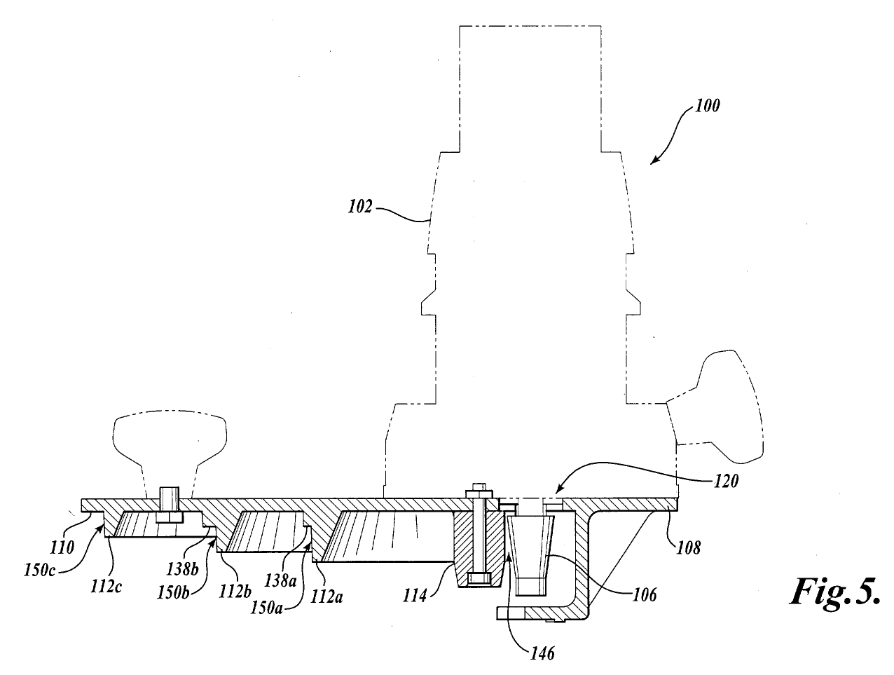

Referring now to FIG. 5, a cross-sectional illustration of the attachment 108 of FIG. 4 is provided. As described previously, the aperture 120 in the attachment plate 110 allows the bit 106 to pass therethrough and lie adjacent the roller guide 114. A small clearance space 146 is allowed between the roller guide 114 and the bit 106. The clearance space 146 can be increased or decreased to vary the amount of bevel desired or to accommodate different pipe wall thicknesses. The bit 106 is a conventional bit. Suitably, the bit 106 can be interchangeable with other bits, for example, to provide for a varying degree of beveling angles. The bit 106 can include one or more blades that are connected along the length of the bit body. Two straight-edged blades may be placed opposite to each other, for example. The cross section of roller guide 114 shows that the roller guide can be provided with angled end portion so as to facilitate the insertion of pipes on the plate attachment 108.

FIG. 5 shows more clearly the arrangement of inserts 112a, 112b, and 112c and the corresponding ledges 138a, 138b. As mentioned previously, the outer surfaces 150a, 150b, and 150c correspond to the tangent points of predetermined circles. When the circles correspond to standardized pipe inner circumferences, the surfaces 150a, 150b, and 150c support the inner wall of the plastic pipes to be beveled. As is clearly shown in FIG. 5, the pipe ends would abut the ledges 138a and 138b on inserts 112a and 112b, respectively, but the pipe would abut the plate 110 for insert 112c. The height and width of ledges 138a and 138b can be varied to accommodate varying pipe thicknesses and the amount of desired bevel. If the ledges 138a and 138b are provided higher along the surface of their corresponding insert, the corresponding bevel produced by bit 106 will be shorter.

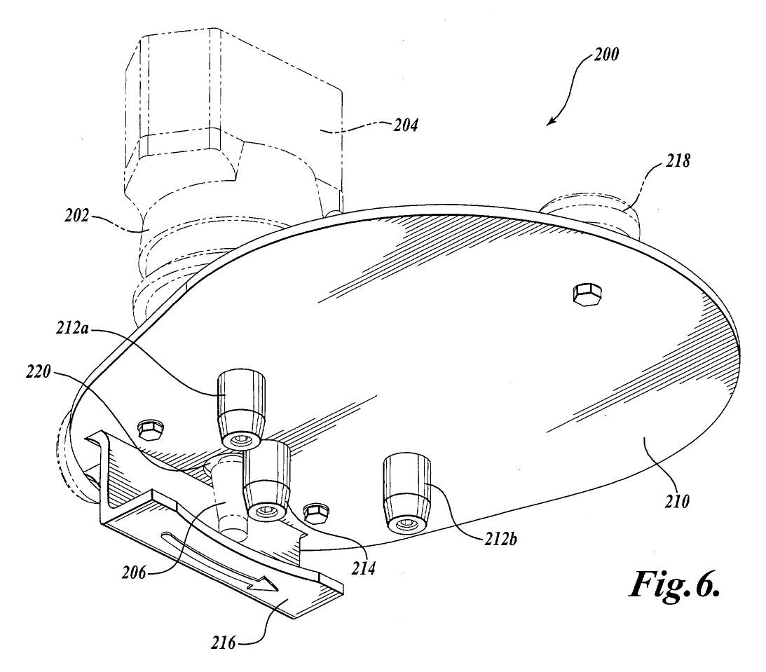

Referring now to FIG. 6, an alternate embodiment of a tool attachment 200 is illustrated. The embodiment of FIG. 6 includes a plate 210. The plate 210 has a roller guide 214 mounted on one side thereof. The plate 210 has an aperture 220 to provide for access to the bit 206. Similar to the previous embodiment, the embodiment of FIG. 6 allows the bit 206 to be located adjacent the roller guide 214. The embodiment of FIG. 6 includes inserts 212a and 212b. The inserts 212a and 212b can be made similar to the roller guide 214, which is also similar to guide 114. However, in other alternates, the guide 214, and inserts 212a and 212b, can be fixed posts, for example, a nonrotating guide and inserts.

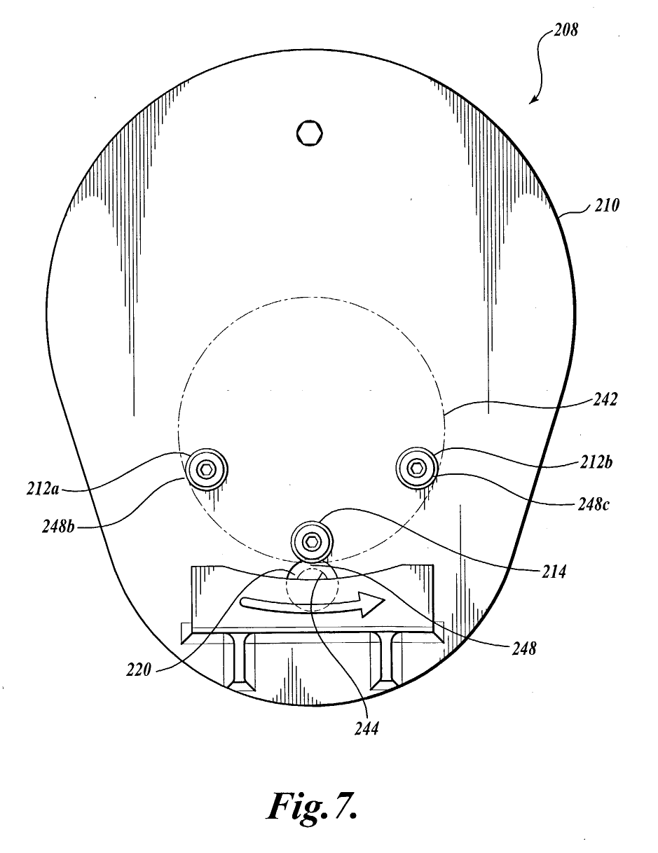

Referring now to FIG. 7, a plan view illustration of the embodiment of FIG. 6 is provided. The outermost surfaces of inserts 212a and 212b lie adjacent or on the circumference of the circle 242. The roller inserts 212a and 212b are made to have at least one tangent point in common with a tangent point of circle 242. The outermost surface of guide 214 also lies adjacent or directly on the circumference of the circle 242 so that at least one tangent point on the guide is in common with one tangent point on the circle 242. The bit outline denoted by reference numeral 244 is shown so that a small clearance space 248 is provided between the eventual bit position denoted by numeral 244 and the roller guide 214. In one embodiment, the circle 242 is approximately the size of any standardized pipe inner circumference. In this manner, the pipe can be inserted so that surfaces of the guide 214, and inserts 212a and 212b will lie in close proximity to the inside wall of a pipe. Thus, the pipe can be rotated in the direction shown by the arrow with minimal play, and thus a consistent bevel can be applied to the exterior edge of the pipe.

In operation, the driver can be either battery powered or the driver can be connected to any standard outlet of normal voltage. The driver drives the rotation of the bit. The angled cutting edges provided on the bit will provide a clean and smooth bevel to plastic pipes, for example. The pipe may be manually turned in the indication of indicator arrows to provide a bevel in a fraction of the time it would take for a manual tool. The tool of the invention significantly reduces the effort to bevel pipes.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A beveling tool, comprising:
(a) a driver;
(b) a bit connected to the driver; and
(c) an attachment connected to the driver, said attachment comprising:
(i) a plate;
(ii) a guide on the plate; and
(iii) one or more inserts on the plate, the one or more inserts approximately defining one or more points on one or more circles, wherein each circle has a point at a location between the guide and the bit.

2. The tool of claim 1, wherein the guide is a roller guide.

3. The tool of claim 1, wherein the one or more inserts are continuous for a majority of the circle.

4. The tool of claim 1, wherein the one or more inserts are discrete or discontinuous inserts.

5. The tool of claim 1, wherein the one or more inserts are roller inserts.

6. The tool of claim 1, wherein the one or more circles approximately define the inner circumference of standardized pipe sizes.

7. A beveling tool, comprising:
(a) a driver having a shaft;
(b) a bit connected to the shaft; and
(c) an attachment connected to the driver, wherein the attachment comprises a plate; a guide on the plate; wherein the bit protrudes through the plate; and wherein the attachment further comprises one or more inserts, and the one or more inserts and the guide approximately define one or more points on a circle.

8. The tool of claim 7, wherein the guide is a roller guide.

9. The tool of claim 7, wherein the one or more inserts are continuous for a majority of the circle.

10. The tool of claim 7, wherein the one or more inserts are discrete or discontinuous inserts.

11. The tool of claim 7, wherein the one or more inserts are roller inserts.

12. The tool of claim 7, wherein the one or more circles approximately define the inner circumference of standardized pipe sizes.

13. A beveling tool, comprising:
(a) a plate;
(b) a guide on the plate; and
(c) one or more inserts on the plate, wherein the guide and the one or more inserts approximately define points on one or more circles.

14. The tool of claim 13, wherein the guide is a roller guide.

15. The tool of claim 13, wherein the one or more inserts are continuous for a majority of the circle.

16. The tool of claim 13, wherein the one or more inserts are discrete or discontinuous inserts.

17. The tool of claim 13, wherein the one or more inserts are roller inserts.

18. The tool of claim 13, wherein the circle approximately defines the inner circumference of a standardized pipe size.

19. A beveling tool, comprising:
(a) a driver having a shaft;
(b) a bit connected to the shaft; and
(c) an attachment connected to the driver, wherein the attachment comprises:
(i) a plate;
(ii) a roller guide on a side of the plate opposite the side connected to the driver;
(iii) an aperture in proximity to the guide, wherein the bit protrudes through the aperture; and
(iv) at least one insert on the plate, wherein the outermost surface of the insert and the outermost surface of the guide approximately define points on a circle.

20. The tool of claim 19, wherein the insert is a roller insert.

21. The tool of claim 19, wherein the insert's outermost surface defines a majority of the circumference of the circle.

22. A beveling tool, comprising:
(a) a plate;
(b) a guide on the plate; and
(c) at least one insert, wherein the outermost surface of the insert and the outermost surface of the guide define points on a circle.

23. The tool of claim 22, wherein the insert is a roller insert.

24. The tool of claim 22, wherein the insert defines a majority of the circumference of the circle.

25. The tool of claim 22, wherein the insert defines less than a majority of the circumference of the circle.

26. A beveling tool, comprising:
(a) a plate;
(b) a guide on the plate; and
(c) one or more inserts on the plate, wherein the inserts define a portion of a circle.
